(19) United States
(12) Patent Application Publication
(10) Pub. No.: US 2013/0037396 A1
(43) Pub. Date: Feb. 14, 2013

(54) SWITCH ASSEMBLY

(71) Applicant: Tsung-Mou Yu, New Taipei City (TW)

(72) Inventor: Tsung-Mou Yu, New Taipei City (TW)

(21) Appl. No.: 13/209,372

(22) Filed: Aug. 13, 2011

(51) Int. Cl. H01H 21/04

(52) U.S. Cl. 200/293

(57) ABSTRACT

A switch assembly includes a switch casing and a button pivotally connected with the switch casing. The switch casing has at least two sets of fastener slots disposed at two sides of the switch casing, respectively. The cover plate has a set of hooks corresponding to the fastener slots. The hooks are engaged with either set of the fastener slots. In addition, an upper side of the switch casing where the button is pivotally connected includes at least one positioning protrusion that is correspondingly engaged with a positioning groove provided on the cover plate to prevent erroneous assembly of the cover plate with the switch casing.

### BACKGROUND OF THE INVENTION

1. Field of the Invention

The present invention relates to a switch assembly, and more particularly to a switch assembly having a switch casing that has at least two sets of fastener slots disposed at two sides of the switch casing to engage with a set of hooks of a cover plate.

2. The Prior Arts

Many switch assembly are currently available in the market. As shown in FIG. 1, a conventional switch assembly includes a switch casing 100, a button 101 disposed at an upper side of the switch casing 100, an extending edge 102 provided at a periphery of the button 101, and two resilient fasteners 103 respectively disposed at two sides of the switch casing 100. When the switch casing 100 is assembled with a cover plate 104, the switch casing 100 is inserted into an opening 105 from an upper side of the cover plate 104. The switch casing is disposed below the cover plate 104 and the button 101 is exposed out of the cover plate 104. The fasteners 103 snap with an edge of the opening 105 and the edge 102 covers the openings 105.

However, the switch assembly mentioned above has the following disadvantages. First of all, the switch casing 100 is inserted into the openings 105 from the upper side of the cover plate 104, and the peripheral rim of the opening 105 has to be provided with a slot to engage with the edge 102, as shown in FIG. 1. As a result, the structure of the cover plate 104 is complicated and the size and shape of the cover plate 104 is restricted. Secondly, the switch casing 100 has to be inserted into the opening 105 from the upper side of the cover plate 104, which restricts the assembling method of the switch assembly. Thirdly, once the switch casing 100 is assembled with the cover plate 104, the switch casing 100 cannot be disassembled. Thus, it is troublesome to repair.

Therefore, the conventional switch assembly still needs improvements.

### SUMMARY OF THE INVENTION

A primary objective of the present invention is to provide a switch assembly that can solve the aforementioned problems, such as the structure of components being too complicated, assembling method being restricted and the switch assembly being unable to disassemble.

To achieve the objective, a switch assembly according to the present invention includes a switch casing having at least two sets of fastener slots respectively disposed at two sides of the switch casing. A cover plate has a set of hooks corresponding to the fastener slots. The hooks are engaged with either set of the fastener slots. In addition, an upper side of the switch casing where the button is pivotally connected includes at least one positioning protrusion that correspondingly mates with a positioning groove provided on the cover plate to prevent erroneous assembly of the cover plate.

According to another embodiment, the upper side of the switch casing where the button is pivotally connected includes two positioning protrusions of different sizes, and an inner edge of the opening through the cover plate includes two positioning grooves of different sizes into which the positioning protrusions can fit to prevent erroneous assembly of the cover plate.

The fastener slots according to the present invention allow the cover plate to assemble with the switch casing from the upper side or the lower side of the switch casing. Therefore, the switch assembly can be assembled from both directions. Furthermore, the engagement between the positioning protrusion of the switch casing and the positioning groove of the cover plate can prevent erroneous assembly of the switch casing and the cover plate. Thus, it reduces the assembling time.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic view showing a conventional switch assembly and a cover plate;

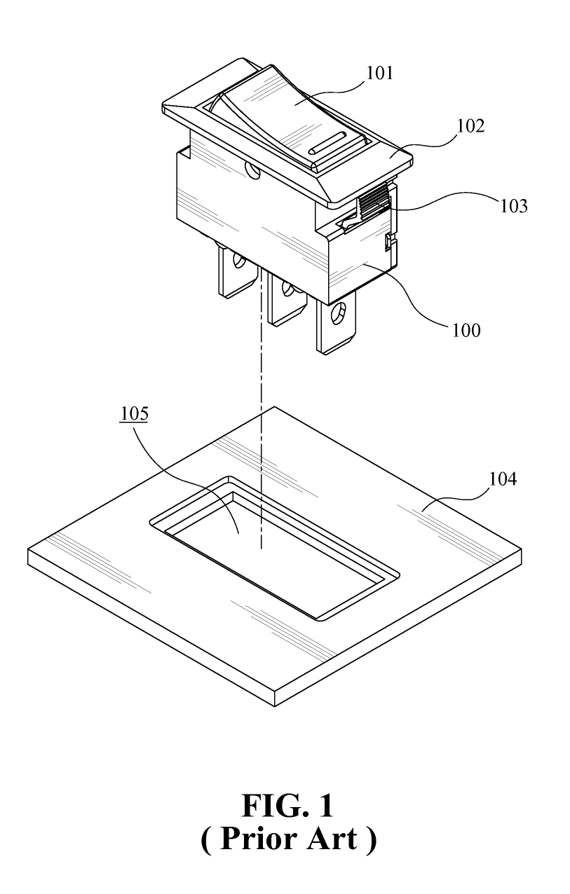

FIG. 2 is a perspective view showing a switch assembly according to an embodiment of the present invention;

FIG. 3 is a schematic view showing the switch assembly according to the present invention to assemble with a cover plate; and

FIG. 4 is a schematic view showing the switch assembly according to the present invention to assemble with a cover plate in a direction different from that of FIG. 3.

### DETAILED DESCRIPTION OF THE PREFERRED EMBODIMENTS

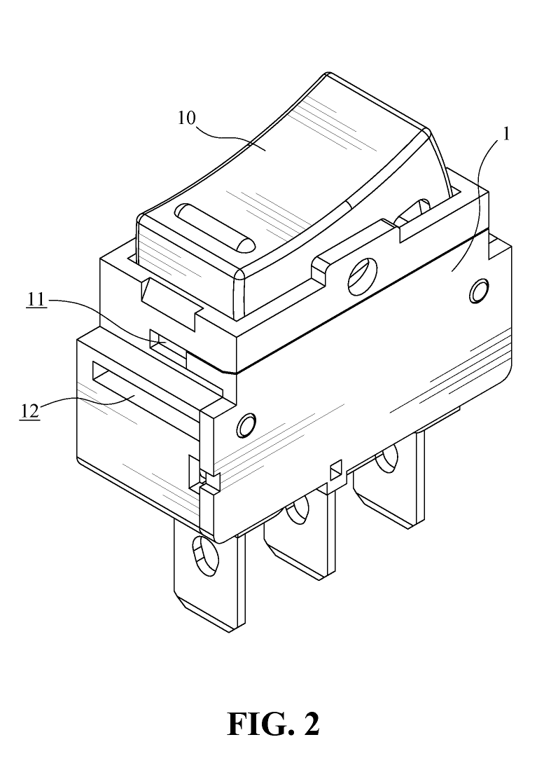

Referring to FIGS. 2 to 4, a switch assembly according to an embodiment of the present invention includes a switch casing 1 and a button 10 pivotally connected with the switch casing 1. The switch casing 1 includes at least two sets of fastener slots 11 and 12. A set of first fastener slots 11 are disposed at two sides of the switch casing 1, respectively. A set of second fastener slots 12 are disposed at two sides of the switch casing 1, respectively. The first fastener slots 11 are located above the second fastener slot 12.

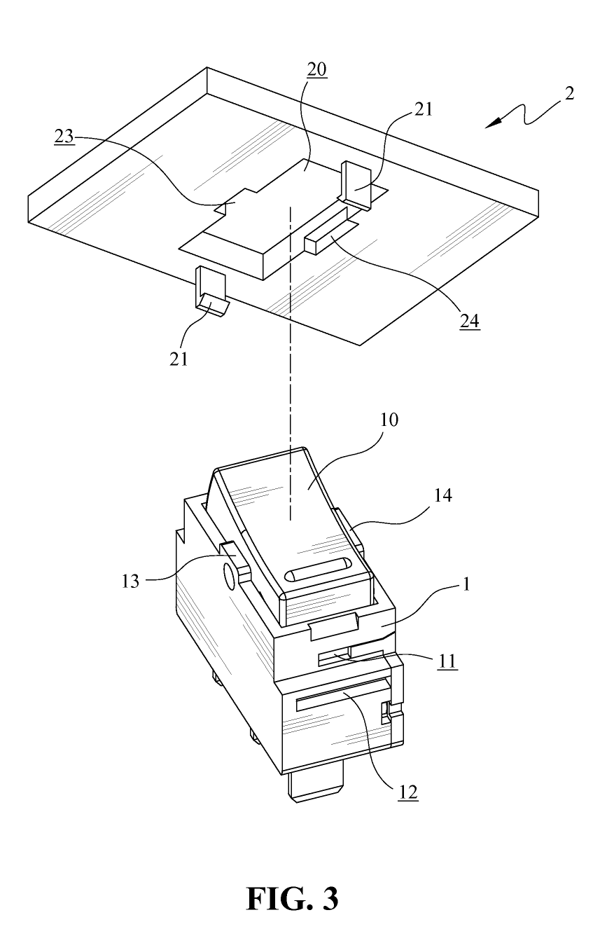

Referring to FIG. 3, the button 10 is pivotally connected with the switch casing 1 to turn the circuit to “ON” or “OFF” states. A cover plate 2 has a set of hooks 21 corresponding to the first fastener slots 11 and the second fastener slots 12 of the switch casing 1. The hooks 21 are extended from a lower surface of the cover plate 2 and respectively disposed at two sides of an opening 20. The hooks 21 are engaged with the first fastener slots 11 or the second fastener slots 12.

The switch casing 1 includes at least one positioning protrusion disposed at an upper side thereof The cover plate 2 includes at least one positioning groove corresponding to the positioning protrusion of the switch casing 1. The positioning protrusion engages with the positioning groove to prevent erroneous assembly of the switch casing 1 and the cover plate 2.

According to the embodiment, the upper side of the switch casing 1 where the button 10 is pivotally connected includes two positioning protrusions 13 and 14 of different sizes as shown in FIG. 3. An inner edge of the opening 20 through the cover plate 2 includes two positioning grooves 23 and 24 of different sizes into which the positioning protrusions 13 and 14 can fit to prevent erroneous assembly of the switch casing 1 and the cover plate 2. FIG. 3 shows that the cover plate 2 is connected with the switch casing 1 from an upper side of the switch casing 1.

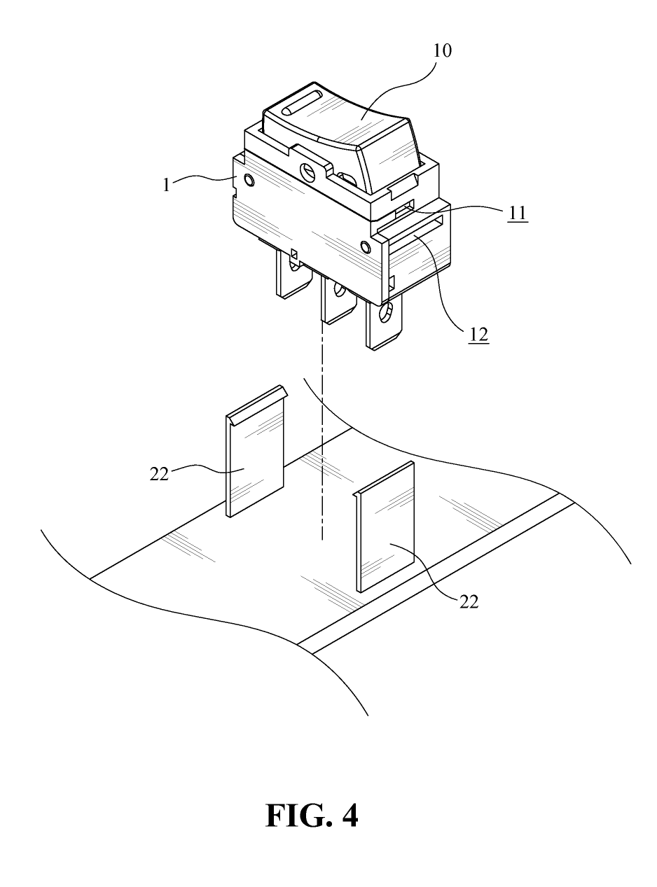

FIG. 4 is a schematic view showing that the switch casing 1 is connected with a cover plate in a direction opposite to that of FIG. 3. The hooks 22 protrude upward to be engaged with the second fastener slots 12 of the switch casing 1, thereby assembling the switch casing 1 with the cover plate. Therefore, the switch assembly according to the present invention can be assembled in multiple directions and methods.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A switch assembly, comprising:
a switch casing having at least two sets of fastener slots respectively disposed at two sides of the switch casing for use in the engagement with a set of hooks disposed on a cover plate.

2. The switch assembly as claimed in claim 1, wherein an upper side of the switch casing comprises at least one positioning protrusion for use in the engagement with at least one positioning groove of the cover plate.

3. The switch assembly as claimed in claim 1, wherein the upper side of the switch casing comprises two positioning protrusions having different sizes each for use in the engagement with a corresponding positioning groove of the cover plate.
